(19) United States
(12) Patent Application Publication
(10) Pub. No.: US 2022/0266862 A1
(43) Pub. Date: Aug. 25, 2022

(54) INTELLIGENT URGENT STOP SYSTEM FOR AN AUTONOMOUS VEHICLE

(71) Applicant: Autonomous Solutions, Inc., Mendon, UT (US)

(72) Inventors: Taylor Bybee, Mendon, UT (US); Austin Costley, Mendon, UT (US); Nathan Bunderson, Mendon, UT (US); Randy Christensen, Mendon, UT (US); Jeffrey Ferrin, Mendon, UT (US)

(21) Appl. No.: 17/681,199

(22) Filed: Feb. 25, 2022

Related U.S. Application Data
(60) Provisional application No. 63/153,932, filed on Feb. 25, 2021.

(51) Int. Cl. B60W 60/00

(52) U.S. Cl. CPC B60W 60/0015; B60W 2520/10; B60W 2520/06; B60W 2556/40; B60W 2420/52; B60W 2420/54; B60W 2420/42; B60W 2540/221; B60W 2720/106

(57) ABSTRACT

An autonomous vehicle urgent stop system is disclosed. The autonomous vehicle urgent stop system may include one or more vehicle sensors and/or one or more environmental sensors that either part of the autonomous vehicle or separate from the autonomous vehicle sensors. The urgent stop system may map a safe-stop trajectory for the autonomous vehicle based on the trajectory of the autonomous vehicle and environmental data received from an environmental sensor. The safe-stop trajectory ends in the autonomous vehicle being stopped. In response to an emergency trigger event, the urgent stop system may direct the autonomous vehicle to follow the safe-stop trajectory.

### BACKGROUND

In normal operation, an autonomous vehicle may autonomously control its operation, for example, based on high level instructions. For instance, an autonomous vehicle may be capable of operating with limited or even no human direction beyond the high-level instructions. As such, an autonomous vehicle may be utilized in a wide array of operations, particularly when operation is relatively predictable. In such instances, circumstances may arise making operations unpredictable. It may be necessary for an autonomous vehicle to perform an emergency stop to prevent or mitigate negative consequences.

### SUMMARY

An autonomous vehicle urgent stop system is disclosed. The autonomous vehicle urgent stop system may include one or more vehicle sensors and/or one or more environmental sensors that either part of the autonomous vehicle or separate from the autonomous vehicle sensors. The urgent stop system may map a safe-stop trajectory for the autonomous vehicle based on the trajectory of the autonomous vehicle and environmental data received from an environmental sensor. The safe-stop trajectory ends in the autonomous vehicle being stopped. In response to an emergency trigger event, the urgent stop system may direct the autonomous vehicle to follow the safe-stop trajectory.

An autonomous vehicle is disclosed that includes a speed control system; a steering system; an environmental sensor; a geolocation sensor that produces geolocation data; and an autonomous vehicle controller communicatively coupled with the speed control system, the steering system, the first environmental sensor, and the geolocation sensor. The autonomous vehicle controller directs the vehicle along a vehicle trajectory by sending signals to the speed control system and the steering control system.

The autonomous vehicle also includes an urgent stop environmental sensor; and an urgent stop controller coupled with the urgent stop environmental sensor. The urgent stop controller may map a safe-stop trajectory for the autonomous vehicle based on the vehicle trajectory data and environmental data received from the urgent stop environmental sensor, wherein the safe-stop trajectory ends in the autonomous vehicle being stopped. The urgent stop controller may, for example, in response to an emergency trigger event, direct the autonomous vehicle to follow the safe-stop trajectory by sending signals to the speed control system and the steering system.

The urgent stop environmental sensor, for example, sensors one or more obstacles, and wherein the safe-stop trajectory avoids the one or more obstacles.

The vehicle trajectory data, for example, includes one or more of the following: velocity, geolocation, poise, heading, and position.

The urgent stop environmental sensor, for example, includes one or more of the following: radar, lidar, visual sensor, and sonar.

The emergency trigger event may, for example include a trigger from the following: human input, a biological indicator, detection of unsafe conditions, and an emergency event.

For example, if the urgent stop environmental sensor does not sense an environmental obstacle, the safe-stop trajectory follows the path. if urgent stop environmental sensor sense an environmental obstacle along the path, the safe-stop trajectory does not follow the path.

The vehicle trajectory data, for example, include vehicle speed, and wherein the safe-stop trajectory comprises a deceleration from the vehicle speed to a stop.

A method for controlling an autonomous vehicle is disclosed. The method includes receiving vehicle trajectory data from a vehicle sensor on an autonomous vehicle; receiving environmental data from an environmental sensor on the autonomous vehicle; mapping a safe-stop trajectory for the autonomous vehicle based on the vehicle trajectory data and the environmental data, wherein the safe-stop trajectory ends in the autonomous vehicle being stopped; directing the autonomous vehicle along a path; receiving notification of an emergency trigger event; and in response to receiving the emergency trigger event, directing the autonomous vehicle to follow the safe-stop trajectory.

The environmental data, for example, may include one or more obstacles, and wherein the safe-stop trajectory avoids the one or more obstacles.

The vehicle trajectory data may include one or more of the following: velocity, geolocation, poise, heading, and position.

The environmental data, for example, may include one or more of the following: radar data, lidar data, visual data, and sonar data.

The emergency trigger event, for example, may include a trigger from the following humanly input, a biological indicator, detection of unsafe conditions, and an emergency event.

For example, if the environmental sensors do not sense an environmental obstacle, the safe-stop trajectory follows the path. For example, if the environmental sensors sense an environmental obstacle along the path, the safe-stop trajectory does not follow the path.

The vehicle trajectory data, for example, includes vehicle speed, and wherein the safe-stop trajectory comprises a deceleration from the vehicle speed to a stop.

The directing the autonomous vehicle along a path, for example, includes receiving environmental data from a second environmental sensor on the autonomous vehicle. The directing the autonomous vehicle to follow the safe-stop trajectory, for example, comprises sending an instruction to an autonomous vehicle controller. The directing the autonomous vehicle to follow the safe-stop trajectory, for example, comprises sending an instruction to the autonomous vehicle's speed control system and/or the autonomous vehicle's steering control system.

An intelligent urgent stop system for an autonomous vehicle is disclosed. The intelligent urgent stop system may include a path estimator. The path estimator may comprise an input that receives at least one environmental parameter from at least one environmental sensor, wherein the path estimator is operable to calculate obstacle data based on the at least one environmental parameter. The path estimator may comprise an output operable to output the obstacle data. The intelligent urgent stop system may further comprise a vehicle state estimator. The vehicle state estimator may comprise an input that receives at least one vehicle parameter from at least one vehicle sensor, wherein the vehicle state estimator is operable to calculate dynamic vehicle data. The vehicle state estimator may comprise an output operable to output the dynamic vehicle data. The intelligent urgent stop system may include an emergency trigger. The emergency trigger may include an input that receives an emergency trigger signal and an output operable to output an emergency trigger data upon an emergency trigger event occurring. The intelligent urgent stop system may comprise an urgent stop controller communicatively coupled to each of the path estimator, the vehicle state estimator and the emergency trigger. The urgent stop controller may include a path input that receives the obstacle data. The urgent stop controller may further comprise a vehicle state input that receives the dynamic vehicle data. The urgent stop controller may further comprise an emergency trigger input that receives emergency trigger data. The urgent stop controller may further comprise a path control system communicatively coupled to each of the path input and the vehicle state input, wherein the path control comprises a path output operable to output a steering angle instruction, a desired acceleration, a desired stopping distance, and a desired velocity. The urgent stop controller may further comprise an acceleration control. The acceleration control may comprise at least one acceleration input communicatively coupled to the path output, wherein the at least one acceleration input is that receives from the path output the desired acceleration, the desired stopping distance, and the desired velocity. The acceleration control may comprise at least one acceleration output operable to output a braking instruction and a throttle instruction. Further, upon receiving the emergency trigger signal, the acceleration control sends the braking instruction and the throttle instruction.

Embodiments of the present disclosure may further comprise an autonomous vehicle. The autonomous vehicle may include a speed control system, a steering system, a geolocation sensor that can produce vehicle geolocation data, a transceiver that can communicate with and receive data from at least a base station, and a controller communicatively coupled with the speed control system, the steering system, the geolocation sensor, and the transceiver. The autonomous vehicle may further comprise a slip estimator. The slip estimator may comprise at least one input that receives at least one environmental parameter from at least one vehicle sensor. The slip estimator may be operable to calculate a coefficient of friction between tires of the autonomous vehicle and a driving surface. The slip estimator may further comprise an output operable to output the coefficient of friction. The autonomous vehicle may further comprise an emergency trigger. The emergency trigger may comprise an input that receives an emergency trigger signal and an output operable to output emergency trigger data upon an emergency trigger event occurring. The autonomous vehicle may further comprise an urgent stop controller communicatively coupled to the slip estimator and the emergency trigger. The urgent stop controller may include a kinetic friction input to receive the coefficient of friction from the slip estimator. The urgent stop controller may further comprise a path input that receives the path information from the autonomous vehicle. The urgent stop controller may further comprise an obstacle data input to receive obstacle information from a vehicle remote sensor. The urgent stop controller may further comprise a navigation input to receive real-time vehicle data from the autonomous vehicle. The urgent stop controller may further comprise an emergency trigger input that receives emergency trigger data. The urgent stop controller may further comprise a path control system. The path control system may be communicatively coupled to each of kinetic friction input, the path input, the obstacle data input, and the navigation input. The path control system may include a path output operable to output a steering angle instruction, a desired acceleration, a desired stopping distance, and a desired velocity. The urgent stop controller may further comprise an acceleration control. The acceleration control may comprise an acceleration input communicatively coupled to the path output. The acceleration input may be that receives from the path output the desired acceleration, the desired stopping distance, and the desired velocity. The acceleration control may comprise an acceleration output operable to output a braking instruction and a throttle instruction. Further upon receiving the emergency trigger signal, the acceleration control may send the braking instruction and the throttle instruction.

Embodiments of the present disclosure may include a method of stopping an autonomous vehicle. The method may comprise receiving vehicle data from at least one vehicle sensor. The method may further comprise receiving environmental data from at least one environmental sensor. The method may further comprise mapping an obstacle avoidance path. The method may further comprise mapping an acceleration path. The method may further comprise receiving notification of an emergency trigger event. The method may further comprise activating a switch to communicate the obstacle avoidance path and the acceleration path. The method may further comprise directing an autonomous vehicle away from obstacles using the obstacle avoidance path and the acceleration path. The method may further comprise stopping an autonomous vehicle.

These examples are mentioned not to limit or define the disclosure, but to provide examples to aid understanding thereof. Additional examples are discussed in the Detailed Description, and further description is provided there. Advantages offered by one or more of the various examples may be further understood by examining this specification or by practicing one or more examples presented.

### BRIEF DESCRIPTION OF THE FIGURES

These and other features, aspects, and advantages of the present disclosure are better understood when the following Detailed Description is read with reference to the accompanying drawings.

FIG. 1 illustrates a block diagram of an example autonomous vehicle communication and control system.

FIG. 2 illustrates a block diagram for an of an intelligent urgent stop communication system of the present disclosure.

FIG. 3 illustrates a block diagram for an of an intelligent urgent stop communication system of the present disclosure.

FIG. 4 is an illustration of the autonomous vehicle with an intelligent urgent stop system on a path with obstacles.

FIG. 5 is an illustration of an of an intelligent urgent stop system working with an autonomous vehicle.

FIG. 6 is a flowchart of an example process for performing an urgent stop using an intelligent urgent stop system.

FIG. 7 shows an illustrative computational system for performing functionality to facilitate implementation of examples described herein.

### DETAILED DESCRIPTION

An autonomous vehicle urgent stop system is disclosed. The autonomous vehicle urgent stop system may include one or more vehicle sensors and/or one or more environmental sensors that either part of the autonomous vehicle or separate from the autonomous vehicle sensors. The urgent stop system may map a safe-stop trajectory for the autonomous vehicle based on the trajectory of the autonomous vehicle and environmental data received from an environmental sensor. The safe-stop trajectory ends in the autonomous vehicle being stopped. In response to an emergency trigger event, the urgent stop system may direct the autonomous vehicle to follow the safe-stop trajectory.

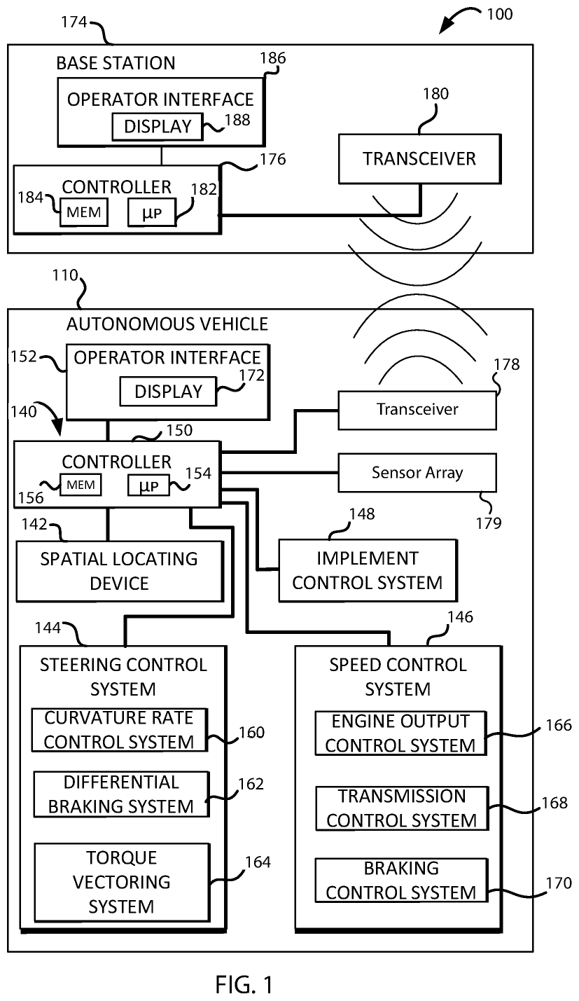

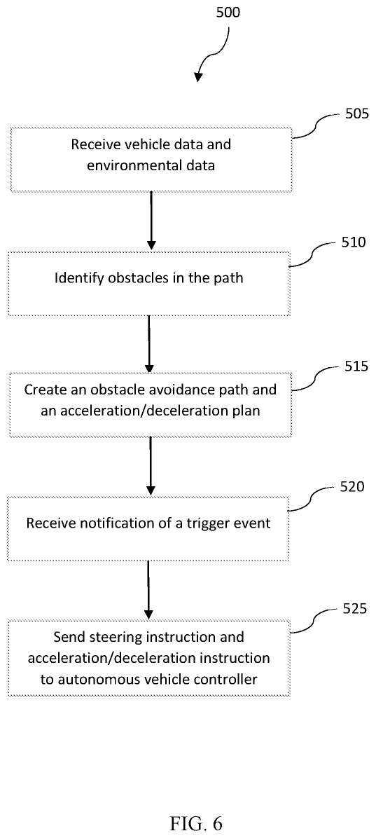

FIG. 1 is a block diagram of an example autonomous vehicle communication and control system 100 that may be utilized in conjunction with the systems and methods of the present disclosure. The communication and control system 100 may include a vehicle control system 140 which may be mounted on an autonomous vehicle 110. The autonomous vehicle 110, for example, may include a loader, wheel loader, track loader, dump truck, digger, backhoe, forklift, etc. The communication and control system 100, for example, may include any or all components of computational unit 600 shown in FIG. 6.

The autonomous vehicle 110, for example, may also include a spatial locating device 142, which may be mounted to the autonomous vehicle 110 and configured to determine a position of the autonomous vehicle 110 as well as a heading and a speed of the autonomous vehicle 110. The spatial locating device 142, for example, may include any suitable system configured to determine the position and/or other characteristics of the autonomous vehicle 110, such as a global positioning system (GPS), a global navigation satellite system (GNSS), or the like. The spatial locating device 142, for example, may determine the position and/or other characteristics of the autonomous vehicle 110 relative to a fixed point within a field (e.g., via a fixed radio transceiver). The spatial locating device 142, for example, may determine the position of the autonomous vehicle 110 relative to a fixed global coordinate system using GPS, GNSS, a fixed local coordinate system, or any combination thereof. The spatial locating device 142, for example, may include any or all components of computational unit 600 shown in FIG. 6.

The autonomous vehicle 110, for example, may include a steering control system 144 that may control a direction of movement of the autonomous vehicle 110. The steering control system 144, for example, may include any or all components of computational unit 600 shown in FIG. 6.

The autonomous vehicle 110, for example, may include a speed control system 146 that controls a speed of the autonomous vehicle 110. The autonomous vehicle 110, for example, may include an implement control system 148 that may control operation of an implement towed by the autonomous vehicle 110 or integrated within the autonomous vehicle 110. The implement control system 148, for example, may include any type of implement such as, for example, a buck, a bucket, a blade, a dump bed, a plow, an auger, a trencher, a scraper, a broom, a hammer, a grapple, forks, boom, spears, a cutter, a tiller, a rake, etc. The speed control system 146, for example, may include any or all components of computational unit 600 shown in FIG. 6.

The control system 140 may include a controller 150 communicatively coupled to the spatial locating device 142, the steering control system 144, to the speed control system 146, and the implement control system 148. The control system 140, for example, may be integrated into a single control system. The control system 140, for example, may include a plurality of distinct control systems. The control system 140, for example, may include any or all components of computational unit 600 shown in FIG. 6.

The controller 150, for example, may receive signals relative to many parameters of interest including, but not limited to: vehicle position, vehicle speed, vehicle heading, desired path location, off-path normal error, desired off-path normal error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof.

The controller 150, for example, may be an electronic controller with electrical circuitry configured to process data from the spatial locating device 142, among other components of the autonomous vehicle 110. The controller 150 may include a processor, such as the processor 154, and a memory device 156. The controller 150 may also include one or more storage devices and/or other suitable components (not shown). The processor 154 may be used to execute software, such as software for calculating drivable path plans. Moreover, the processor 154 may include multiple microprocessors, one or more “general-purpose” microprocessors, one or more special-purpose microprocessors, and/or one or more application specific integrated circuits (ASICS), or any combination thereof. For example, the processor 154 may include one or more reduced instruction set (RISC or CISC) processors. The controller 150 may include any or all components of computational unit 600 shown in FIG. 6.

The memory device 156, for example, may include a volatile memory, such as random-access memory (RAM), and/or a nonvolatile memory, such as ROM. The memory device 156 may store a variety of information and may be used for various purposes. For example, the memory device 156 may store processor-executable instructions (e.g., firmware or software) for the processor 154 to execute, such as instructions for calculating drivable path plan, and/or controlling the autonomous vehicle 110. The memory device 156 may include flash memory, one or more hard drives, or any other suitable optical, magnetic, or solid-state storage medium, or a combination thereof. The memory device 156 may store data such as field maps, maps of desired paths, vehicle characteristics, software or firmware instructions and/or any other suitable data.

The steering control system 144, for example, may include a curvature rate control system 160, a differential braking system 162, and a torque vectoring system 164 that may be used to steer the autonomous vehicle 110. The curvature rate control system 160, for example, may control a direction of an autonomous vehicle 110 by controlling a steering system of the autonomous vehicle 110 with a curvature rate, such as an Ackerman style autonomous vehicle 110. The curvature rate control system 160, for example, may automatically rotate one or more wheels or tracks of the autonomous vehicle 110 via hydraulic actuators to steer the autonomous vehicle 110. By way of example, the curvature rate control system 160 may rotate front wheels/tracks, rear wheels/tracks, and/or intermediate wheels/tracks of the autonomous vehicle 110, either individually or in groups. The differential braking system 162 may independently vary the braking force on each lateral side of the autonomous vehicle 110 to direct the autonomous vehicle 110. Similarly, the torque vectoring system 164 may differentially apply torque from the engine to the wheels and/or tracks on each lateral side of the autonomous vehicle 110. While the illustrated steering control system 144 includes the curvature rate control system 160, the differential braking system 162, and the torque vectoring system 164, it should be appreciated that alternative examples may include one or more of these systems, in any suitable combination. Further examples may include a steering control system 144 having other and/or additional systems to facilitate turning the autonomous vehicle 110 such as an articulated steering system, a differential drive system, and the like.

The speed control system 146, for example, may include an engine output control system 166, a transmission control system 168, and a braking control system 170. The engine output control system 166 may vary the output of the engine to control the speed of the autonomous vehicle 110. For example, the engine output control system 166 may vary a throttle setting of the engine, a fuel/air mixture of the engine, a timing of the engine, and/or other suitable engine parameters to control engine output. In addition, the transmission control system 168 may adjust gear selection within a transmission to control the speed of the autonomous vehicle 110. Furthermore, the braking control system 170 may adjust braking force to control the speed of the autonomous vehicle 110. While the illustrated speed control system 146 includes the engine output control system 166, the transmission control system 168, and the braking control system 170, it should be appreciated that alternative examples may include one or two of these systems, in any suitable combination. Further examples may include a speed control system 146 having other and/or additional systems to facilitate adjusting the speed of the autonomous vehicle 110.

The implement control system 148, for example, may control various parameters of the implement towed by and/or integrated within the autonomous vehicle 110. For example, the implement control system 148 may instruct an implement controller via a communication link, such as a CAN bus or ISOBUS or any other communication networks such as, for example, ethernet, Wi-Fi, Bluetooth, Broad R, LTE, 5G, etc.

The implement control system 148, for example, may instruct an implement controller to adjust a penetration depth of at least one ground engaging tool of an agricultural implement, which may reduce the draft load on the autonomous vehicle 110.

The implement control system 148, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc.

The implement control system 148, as another example, may instruct the implement controller to adjust a shovel height, a shovel angle, a shovel position, etc.

The vehicle control system 100, for example, may include a sensor array 179. The sensor array 179, for example, may facilitate determination of condition(s) of the autonomous vehicle 110 and/or the work area. For example, the sensor array 179 may include multiple sensors (e.g., infrared sensors, ultrasonic sensors, magnetic sensors, radar sensors, Lidar sensors, terahertz sensors, sonar sensors, cameras, etc.) that monitor a rotation rate of a respective wheel or track and/or a ground speed of the autonomous vehicle 110. The sensors may also monitor operating levels (e.g., temperature, fuel level, etc.) of the autonomous vehicle 110. Furthermore, the sensors may monitor conditions in and around the work area, such as temperature, weather, wind speed, humidity, and other conditions. The sensors may detect physical objects in the work area, such as the parking stall, the material stall, accessories, other vehicles, other obstacles, or other object(s) that may in the area surrounding the autonomous vehicle 110. Further, the sensor array 179 may be utilized by the first obstacle avoidance system, the second obstacle avoidance system, or both.

The operator interface 152 may be communicatively coupled to the controller 150 and configured to present data from the autonomous vehicle 110 via a display 172. Display data may include: data associated with operation of the autonomous vehicle 110, data associated with operation of an implement, a position of the autonomous vehicle 110, a speed of the autonomous vehicle 110, a desired path, a drivable path plan, a target position, a current position, etc. The operator interface 152 may enable an operator to control certain functions of the autonomous vehicle 110 such as starting and stopping the autonomous vehicle 110, inputting a desired path, etc. The operator interface 152, for example, may enable the operator to input parameters that cause the controller 150 to adjust the drivable path plan. For example, the operator may provide an input requesting that the desired path be acquired as quickly as possible, that an off-path normal error be minimized, that a speed of the autonomous vehicle 110 remain within certain limits, that a lateral acceleration experienced by the autonomous vehicle 110 remain within certain limits, etc. In addition, the operator interface 152 (e.g., via the display 172, or via an audio system (not shown), etc.) may alert an operator if the desired path cannot be achieved, for example.

The control system 140, for example, may include a base station 174 having a base station controller 176 located remotely from the autonomous vehicle 110. For example, control functions of the control system 140, for example, may be distributed between the controller 150 of the autonomous vehicle control system 140 and the base station controller 176. The base station controller 176, for example, may perform a substantial portion of the control functions of the control system 140. For example, a first transceiver 178, for example, positioned on the autonomous vehicle 110 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 180 at the base station 174. The base station controller 176, for example, may calculate drivable path plans and/or output control signals to control the curvature rate control system 144, the speed control system 146, and/or the implement control system 148 to direct the autonomous vehicle 110 toward the desired path, for example. The base station controller 176 may include a processor 182 and memory device 184 having similar features and/or capabilities as the processor 154 and the memory device 156 discussed previously. Likewise, the base station 174 may include an operator interface 186 having a display 174, which may have similar features and/or capabilities as the operator interface 152 and the display 172 discussed previously.

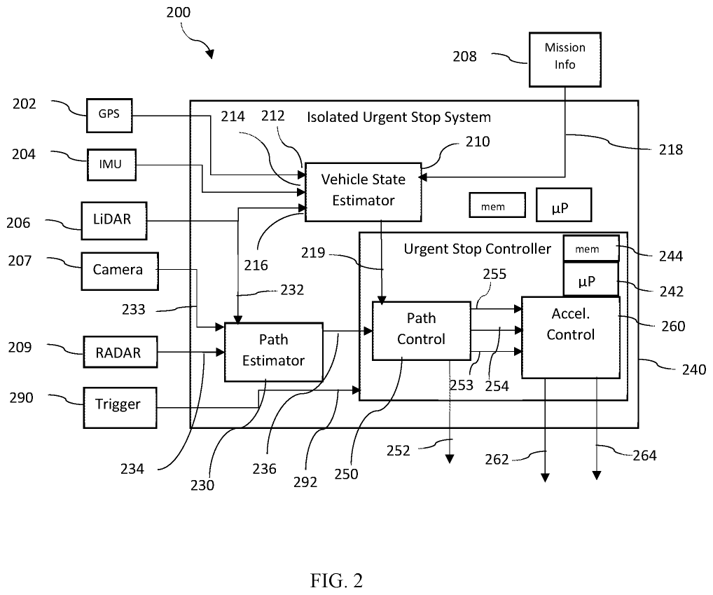

FIG. 2 is an illustration of an intelligent urgent stop (IUS) system 200. The IUS system 202, for example, may be operably coupled to an autonomous vehicle, such as autonomous vehicle 110. The IUS system 200, for example, may be operably coupled to any type of vehicle, such as a drive by-wire vehicle, an autonomous vehicle, a manually operated vehicle, a teleoperated vehicle, etc. The IUS system 200 may control an autonomous vehicle to come to a stop. The IUS system 200, for example, may control an autonomous vehicle to avoid an obstacle by either stopping or by steering the vehicle away from an obstacle. An obstacle may include a person, a vehicle, a structure, a terrain feature, or other obstacle found in the path of a vehicle that could cause damage to the vehicle and/or to the obstacle.

The IUS system 200, for example, may include a vehicle state estimator 210. The vehicle state estimator 210 may output a vehicle data estimation. The autonomous vehicle data estimation may include estimations of the autonomous vehicle velocity, roll, pitch, rollover/center of gravity, traction, location, and/or slippage.

The vehicle state estimator 210 may include a first input 212. The first input 212 may receive a signal from a sensor, such as a global positioning system (GPS) sensor 202 (e.g., spatial locating device 142). The GPS sensor 202 may communicate to the vehicle state estimator 210 a position of the IUS system 200 and the vehicle to which the IUS system is operably coupled. The GPS sensor 202 may communicate with the vehicle state estimator 210 via wired or wireless communication.

The vehicle state estimator 210, for example, may include a second input 214. The second input 214 may receive a signal from a sensor, such as an inertial measurement unit (IMU) sensor 204. The IMU sensor 204 may provide to the vehicle state estimator a specific force of the vehicle, the vehicle's angular rate, and the orientation of the vehicle. The IMU sensor 204 may include a combination of accelerometers, gyroscopes, and/or magnetometers. The IMU sensor 204 may communicate with the vehicle state estimator 210 via wired or wireless communication. The IMU sensor 204 may include all or some of the components of spatial locating device 142.

The vehicle state estimator 210, for example, may include a third input 216. The third input 216 may receive a signal from a remote sensing unit, such as a signal from a Light Detection and Ranging (LiDAR) unit 206. The LiDAR unit 206, for example, may output laser return times and wavelengths. The LiDAR system, for example, may output a range to a target or obstacle, an intensity of an image, and a point cloud of data points. As will be discussed below, such data may be used to create three dimensional representations of the area surrounding the vehicle. The LiDAR unit 206 may communicate with the vehicle state estimator 210 via wired or wireless communication.

The vehicle state estimator 210, for example, may include a fourth input 218. The fourth input 218 may receive a signal from an external source 208. The external source 208 may include the autonomous vehicle. The fourth input 218 may receive mission information regarding the vehicle. The mission information may include many parameters of interest including, but not limited to: desired vehicle speed, desired vehicle heading, desired path location, desired off-path normal error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof.

The vehicle state estimator 210, for example, may comprise an output 219. The vehicle state estimator 210 may output an estimated vehicle velocity, a vehicle roll rate, and a vehicle pitch rate.

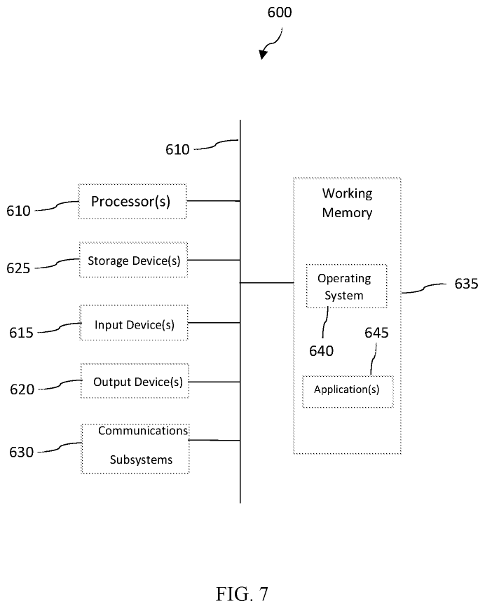

The IUS system 200, for example, may include a path estimator 230. The path estimator may compile obstacle data containing a map of local obstacles and output the obstacle data. The path estimator 230 may comprise an input 232. The path estimator 230 may receive data from the LiDAR unit 206 at the input 232. The path estimator 230 may comprise an input 234. The path estimator 230 may receive data from a RADAR unit 209 at the input 234. The path estimator may comprise an input 233. The path estimator may receive data from a camera 207 at the input 233. The path estimator 230 may use either or both the received data from the LiDAR unit 206, the received data from the RADAR unit 209, and the received data from the camera to produce a map of local obstacles. The path estimator 230, for example, may include any or all the components shown in FIG. 7.

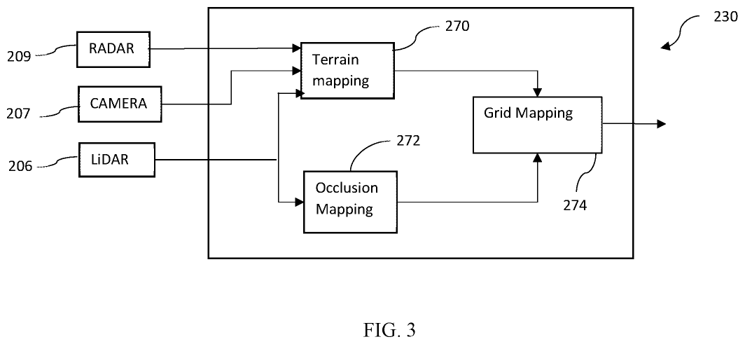

Referring now to FIG. 3, the path estimator 230, for example, may include a terrain mapping system 270. The terrain mapping system 270 may receive either or both point cloud data from the LiDAR unit 206 and data from the RADAR sensors 209. The terrain mapping system 270 may receive data from the camera 207. The terrain mapping system 270 may label each point at terrain or non-terrain. The terrain mapping system 270 may create a map of the terrain and the non-terrain of the sampled area. The terrain mapping system 270, for example, may produce a flat map or a street map.

An odometry estimate, for example, may be input to the terrain mapping system 270. In such cases, a terrain estimate may be stored in a memory of the terrain mapping system 270. The terrain estimate may be updated based on changes in a vehicle position and updates from the LiDAR unit 206, the RADAR 209, and the camera 207. An odometry estimate, for example, may not be available. In such cases, each point cloud may be processed independently.

The path estimator 230, for example, may comprise an occlusion mapping system 272. The occlusion mapping system may receive the point cloud data from the LiDAR unit 206. The occlusion mapping system 272 may create a probability map of the sensor field of view relative to the vehicle to show negative obstacles, such as holes, voids, drop-offs, and the like.

The path estimator 230, for example, may comprise grid mapping system 274. The grid mapping system 274 may be communicatively coupled to each of the terrain mapping system 270 and the occlusion mapping system 272. The grid mapping system 274 may combine the terrain map produced by the terrain mapping system 270 and the probability map produced by the occlusion mapping system 272. The grid mapping system 274 may generate an occupancy grid containing drivable, undrivable, and “not sensed” cells. The path estimator 230 may output the data containing the occupancy grid at output 236.

Referring again to FIG. 2, the IUS system 200, for example, may comprise an urgent stop controller 240. The urgent stop controller 240, for example, may receive signals relative to many parameters of interest including, but not limited to: vehicle position, vehicle speed, vehicle heading, desired path location, off-path normal error, desired off-path normal error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof.

The urgent stop controller 240, for example, may be an electronic controller with electrical circuitry configured to process data from the vehicle state estimator 210 and the path estimator 230, among other components of the autonomous vehicle 110. The urgent stop controller 240 may include a processor, such as the processor 242, and a memory device 244. The urgent stop controller 240 may also include one or more storage devices and/or other suitable components (not shown). The processor 242 may be used to execute software, such as software for calculating drivable path plans. Moreover, the processor 242 may include multiple microprocessors, one or more “general-purpose” microprocessors, one or more special-purpose microprocessors, and/or one or more application specific integrated circuits (ASICS), or any combination thereof. For example, the processor 242 may include one or more reduced instruction set (RISC or CISC) processors. The urgent stop controller 240, for example, may include any or all the components shown in FIG. 7.

The memory device 244, for example, may include a volatile memory, such as random-access memory (RAM), and/or a nonvolatile memory, such as ROM. The memory device 244 may store a variety of information and may be used for various purposes. For example, the memory device 244 may store processor-executable instructions (e.g., firmware or software) for the processor 242 to execute, such as instructions for calculating an urgent stop path plan, and/or an urgent stop acceleration/deceleration. The memory device 244 may include flash memory, one or more hard drives, or any other suitable optical, magnetic, or solid-state storage medium, or a combination thereof. The memory device 244 may store data such as field maps, maps of desired paths, vehicle characteristics, software or firmware instructions and/or any other suitable data.

The urgent stop controller 240 may include a path control system 250. The path control system 250 may receive various estimated data, as will be described. The path control system 250 may produce a steering angle, a desired acceleration/deceleration, a desired stopping distance, and a desired velocity. The path control system 250 may include a steering output 252. The steering output 252 may output a steering angle instruction to the autonomous vehicle.

The path control system 250 may receive dynamic vehicle data from the vehicle state estimator 210, such as the estimated vehicle velocity, the estimated vehicle roll rate, and the estimated vehicle pitch rate. The path control system 250 may also receive data representing a map of local obstacles from the path estimator 230.

The path control system 250 may calculate a steering angle, a desired acceleration/deceleration, a desired stopping distance, and a desired velocity based on these inputs. The path control system may also weigh factors such as desired path velocity, distance to obstacles, distance to end of path, and turning characteristics of the vehicle, if available. The path control system 250, for example, may choose a stopping trajectory that follows the original planned path with a smooth deceleration. Such a path may minimize vehicle wear. If the planned path were to encounter an obstacle, the path control system may choose a more aggressive deceleration profile and/or a different path to ensure the vehicle stops without causing harm to passengers, minimizing the risk of vehicle roll-over, and minimizing the risk of damage and/or wear to the vehicle and to obstacles which may be in the path.

The desired deceleration, for example, may be calculated using an estimated kinetic friction to modulate from a comfortable deceleration to smaller magnitudes in order to avoid slipping. In calculating the desired deceleration, for example, the path control system 250 may weigh human comfort. A stopping profile that does not exceed human comfort levels is less likely to cause undue alarm in vehicle passengers, passengers of neighboring vehicles, or persons monitoring the IUS system 200. Deceleration rates of 3.4 m/s^{s} have been found to be undesirable but not alarming to passengers. For example, a target deceleration rate may not exceed 3.4 m/s², however, the path control system 250 could exceed this rate if required.

The path control system 250, for example, may comprise an acceleration output 253. The acceleration output 253 may output a desired acceleration to an acceleration control 260, as discussed below.

The path control system 250, for example, may include a stopping distance output 254. The stopping distance output 254 may output a desired stopping distance to an acceleration control 260, as discussed below.

The path control system 250, for example, may include a velocity output 255. The velocity output 255 may output a desired velocity, such as for example 0 meters per second, to an acceleration control 260, as discussed below.

The urgent stop controller 240 may comprise an acceleration control system 260. The acceleration control system 260 may receive as inputs a desired acceleration, a desired stopping distance, and a desired velocity from the path control system 250. The acceleration control system 260 may produce a control deceleration and a braking instruction based on the desired acceleration/deceleration, desired stopping distance, and the desired velocity. The acceleration controller 260 may comprise an acceleration output 262. The acceleration output 262 may output the control deceleration. The acceleration controller 260, for example, may include a braking output 264. The braking output 264 may output the braking instruction to an autonomous vehicle.

The IUS system 200 may include an emergency trigger 290. The emergency trigger 290 may send a signal to the urgent stop controller 240. The urgent stop controller 240 may include an emergency trigger input 292. The signal may be received at an emergency trigger input 292. The emergency trigger 290 may send a signal to the urgent stop controller 240 upon the occurrence of an emergency trigger event. The signal may indicate to the urgent stop controller 240 to send a steering angle instruction, a braking instruction, and an acceleration/deceleration instruction on to the autonomous vehicle.

An emergency trigger event, for example, may include a notification of an obstacle in the path that must be avoided. An emergency trigger event, for example, may include a passenger in the autonomous vehicle proactively activating an urgent stop. The emergency trigger, for example, may be coupled to an indicator of a passenger of the autonomous vehicle. An interruption in a biological indicator may act as an emergency trigger event. An emergency trigger event, for example, may comprise an emergency identified by the urgent stop controller 240, such as for example identifying an immediate obstacle in the path.

The control deceleration may have different values. For example, if the desired stopping distance is less than or equal to zero meters or feet, then the control deceleration may be a maximum deceleration value. As another example, if the desired stopping distance is less than or equal to the distance required to stop with the desired acceleration, then the control deceleration may be set to the value required to stop in the desired stopping distance given the vehicle's current velocity, and assuming constant deceleration. As another example, if the desired velocity is zero, then the control deceleration may be set to the desired deceleration.

The desired deceleration may be achieved by a combination of braking commands and throttle commands sent from the acceleration control system. When the vehicle speed decreases to below a threshold value, for example, a brake may be initiated to fully engage a vehicle's braking system. The brake ramp may also be initiated, for example, at a specified time after the IUS system 200 has been emergency triggered. For example, the brake ramp may be initiated 15 seconds after the IUS system 200 has been emergency triggered or initiated.

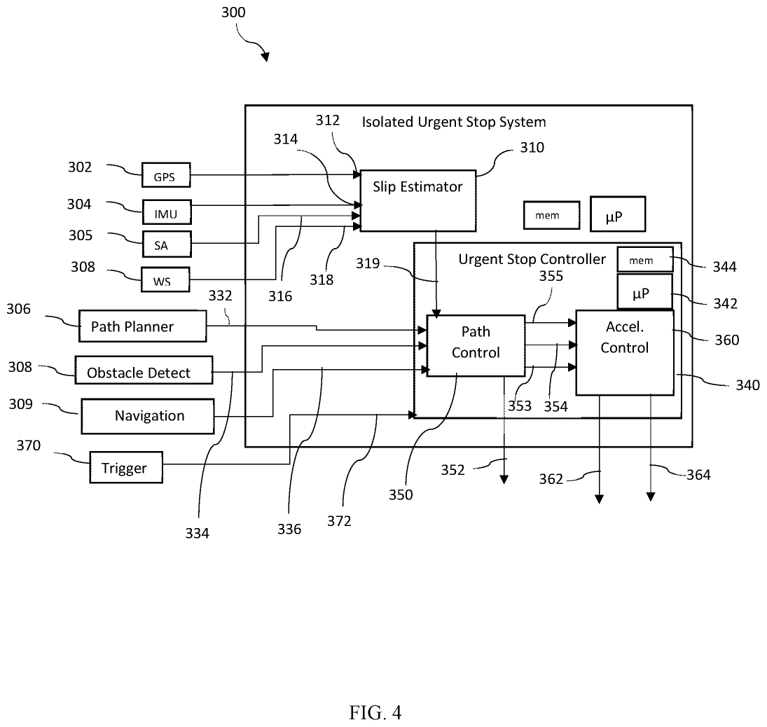

Referring now to FIG. 4, an integrated intelligent urgent stop (IIUS) system 300, for example, may be included. The IIUS system 300 may be integrated with an autonomous vehicle, such as the autonomous vehicle 110. As discussed below, the IIUS system may share with the autonomous vehicle 110 certain systems, subsystems, and/or sensors.

The IIUS system 300, for example, may include a slip estimator 310. The slip estimator 310 may receive sensor data from a sensor array, such as sensor array 179, specifically, the slip estimator 310 may receive GPS data, IMU data, steering angle data, and wheel speed data. The slip estimator 310 may output a vehicle data estimation. The vehicle data estimations may include estimations of the friction coefficient between the vehicle tires and the driving surface.

The slip estimator 310 may include a first input 312. The first input 312 may receive a signal from a sensor, such as a global positioning system (GPS) sensor 302. The GPS sensor 302 may be a GPS sensor of the autonomous vehicle 110. The GPS sensor 302 may output a position of the autonomous vehicle 110. The GPS sensor 302 may communicate with the slip estimator 310 via wired or wireless communication.

The slip estimator 310, for example, may include a second input 314. The second input 314 may receive a signal from a sensor, such as an inertial measurement unit (IMU) sensor 304. The IMU sensor 304 may be integrated with the autonomous vehicle 110 and may gather information regarding vehicle performance. The IMU may output a specific force of the vehicle, the vehicle's angular rate, and the orientation of the vehicle. The IMU sensor 304 may include a combination of accelerometers, gyroscopes, and magnetometers. The IMU sensor 304 may communicate with the slip estimator 310 via wired or wireless communication.

The slip estimator 310, for example, may include a third input 316. The third input 316 may receive information regarding a steering angle or direction of the vehicle from the steering angle sensor (SA) 305.

The slip estimator 310, for example, may include a fourth input 318. The fourth input 318 may receive information regarding the wheel speed of the vehicle from the wheel speed sensor 308.

The slip estimator 310, for example, may comprise an output 319. The slip estimator 310 may output an estimated coefficient of friction between the vehicle tires and the driving surface.

The IIUS system 300, for example, may gather data from the autonomous vehicle with which it is integrated. For example, the IIUS system 300 may use information gathered from sensors of the autonomous vehicle, such as those in sensor array 179, to continuously calculate a safe-stop trajectory, making at least one safe-stop trajectory always available.

As illustrated in FIG. 4, the IIUS system 300 may be in communication with a path planner 306 of an autonomous vehicle. The path planner 306 may comprise mission information, which may include many parameters of interest including, but not limited to: desired vehicle speed, desired vehicle heading, desired path location, desired off-path normal error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. The path planner 306, for example, may include any or all the components shown in FIG. 7.

The IIUS system 300, for example, may be in communication with an obstacle detection system 308. The obstacle detection system 308 may comprise hardware to obtain and compile obstacle data containing a map of local obstacles and output the obstacle data. For example, the obstacle detection system 308 may include a remote sensing unit, such as a Light Detection and Ranging (LiDAR) system. The LiDAR system may output laser return times and wavelengths. The LiDAR system may output a range to a target or obstacle, an intensity of an image, and a point cloud of data points. Such data may be used to create three dimensional representations of the area surrounding the vehicle. As another example, the obstacle detection system 308 may include a RADAR system which may produce images of potential obstacles around the autonomous vehicle. The obstacle detection system 308 may use either or both the received data from the LiDAR system and the received data from the RADAR system to produce a map of local obstacles. The IIUS 300 may comprise an input 334. The IIUS system 300 may receive data from the obstacle detection system 308 at the input 334 and is communicated to the path control 350, as discussed below. The obstacle detection system 308, for example, may include any or all the components shown in FIG. 7.

The IIUS system 300, for example, may be in communication with a navigation system 309 of an autonomous vehicle. The navigation system 309 may comprise real-time data regarding many parameters of interest including, but not limited to: vehicle speed, vehicle heading, path location, off-path normal error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. The IIUS 300 may comprise an input 336. The IIUS 300 may receive data from the navigation system 309 at the input 336 and is communicated to the path control 350, as discussed below. The navigation system 309, for example, may include any or all the components shown in FIG. 7.

The IIUS system 300, for example, may comprise an urgent stop controller 340. The urgent stop controller 340, for example, may receive signals relative to many parameters of interest including, but not limited to: vehicle position, vehicle speed, vehicle heading, desired path location, off-path normal error, desired off-path normal error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof.

The urgent stop controller 340, for example, may be an electronic controller with electrical circuitry configured to process data from the slip estimator 310 and the path planner 306, the obstacle detection system 308, and the navigation system 309, among other components of the autonomous vehicle 110. The urgent stop controller 340 may include a processor, such as the processor 342, and a memory device 344. The urgent stop controller 340 may also include one or more storage devices and/or other suitable components (not shown). The processor 342 may be used to execute software, such as software for calculating drivable path plans. Moreover, the processor 342 may include multiple microprocessors, one or more “general-purpose” microprocessors, one or more special-purpose microprocessors, and/or one or more application specific integrated circuits (ASICS), or any combination thereof. For example, the processor 342 may include one or more reduced instruction set (RISC or CISC) processors. The urgent stop controller 340, for example, may include any or all the components shown in FIG. 7.

The memory device 344, for example, may include a volatile memory, such as random-access memory (RAM), and/or a nonvolatile memory, such as ROM. The memory device 344 may store a variety of information and may be used for various purposes. For example, the memory device 344 may store processor-executable instructions (e.g., firmware or software) for the processor 342 to execute, such as instructions for calculating an urgent stop path plan, and/or an urgent stop acceleration/deceleration. The memory device 344 may include flash memory, one or more hard drives, or any other suitable optical, magnetic, or solid-state storage medium, or a combination thereof. The memory device 344 may store data such as field maps, maps of desired paths, vehicle characteristics, software or firmware instructions and/or any other suitable data.

The urgent stop controller 340 may include a path control system 350. The path control system 350 may receive various estimated data, as will be described. The path control system 350 may produce a steering angle, a desired acceleration/deceleration, a desired stopping distance, and a desired velocity.

The path control system 350 may receive dynamic vehicle data from the slip estimator 310, such as the estimated coefficient of friction between the vehicle tires and the driving surface.

The path control system 350 may calculate a steering angle, a desired acceleration/deceleration, a desired stopping distance, and a desired velocity based on these inputs. The path control system may also weigh factors such as desired path velocity, distance to obstacles, distance to end of path, and turning characteristics of the vehicle, if available. The path control system 350 may include a steering output 352. The steering output 352 may output a steering angle instruction to the autonomous vehicle.

The desired deceleration, for example, may be calculated using an estimated kinetic friction to modulate from a comfortable deceleration to smaller magnitudes in order to avoid slipping. In calculating the desired deceleration, the path control system 350, for example, may weigh human comfort. A stopping profile that does not exceed human comfort levels is less likely to cause undue alarm in vehicle passengers, passengers of neighboring vehicles, or persons monitoring the IIUS system 300. Deceleration rates of 3.4 m/s² have been found to be undesirable but not alarming to passengers. For example, a target deceleration rate may not exceed 3.4 m/s², however, the path control system 350 could exceed this rate if required.

The path control system 350, for example, may comprise an acceleration output 353. The acceleration output 353 may output a desired acceleration to an acceleration control 360, as discussed below.

The path control system 350, for example, may include a stopping distance output 354. The stopping distance output 354 may output a desired stopping distance to an acceleration control 360, as discussed below.

The path control system 350, for example, may include a velocity output 355. The velocity output 355 may output a desired velocity, such as for example 0 meters per second, to an acceleration control 360, as discussed below.

The urgent stop controller 340 may comprise an acceleration control system 360. The acceleration control system 360 may receive as inputs a desired acceleration, a desired stopping distance, and a desired velocity from the path control system 350. The acceleration control system 360 may produce a control deceleration based on the desired acceleration, desired stopping distance, and the desired velocity.

The control deceleration may have different values. For example, if the desired stopping distance is less than or equal to zero meters or feet, then the control deceleration may be a maximum deceleration value. As another example, if the desired stopping distance is less than or equal to the distance required to stop with the desired acceleration, then the control deceleration may be set to the value required to stop in the desired stopping distance given the vehicle's current velocity, and assuming constant deceleration.

As another example, if the desired velocity is zero, then the control deceleration may be set to the desired deceleration. A control deceleration, for example, may be generated from a PID control based on the error signal difference between current velocity and the desired velocity.

The desired deceleration may be achieved by a combination of braking commands and throttle commands sent from the acceleration control system. When the vehicle speed decreases to below a threshold value, for example, a brake may be initiated to fully engage a vehicle's braking system. The brake ramp, for example, may also be initiated at a specified time after the IIUS system 300 has been emergency triggered. For example, the brake ramp may be initiated 15 seconds after the IIUS system 300 has been emergency triggered or initiated.

The IIUS system 300 may include an emergency trigger 370. The emergency trigger 370 may send a signal to the urgent stop controller 340. The urgent stop controller 340 may include an emergency trigger input 372. The signal may be received at the emergency trigger input 372.The emergency trigger 370 may send a signal to the urgent stop controller 340 upon the occurrence of an emergency trigger event. The signal may indicate to the urgent stop controller 340 to send the steering angle instruction, the braking instruction, and the acceleration/deceleration instruction on to the autonomous vehicle.

An emergency trigger event, for example, may include a notification of an obstacle in the path that must be avoided. An emergency trigger event, for example, may include a passenger in the autonomous vehicle proactively activating an urgent stop. The emergency trigger, for example, may be coupled to an indicator of a passenger of the autonomous vehicle. An interruption in such a biological indicator, for example, may act as an emergency trigger event. An emergency trigger event, for example, may comprise an emergency identified by the urgent stop controller 340, such as for example identifying an immediate obstacle in the path.

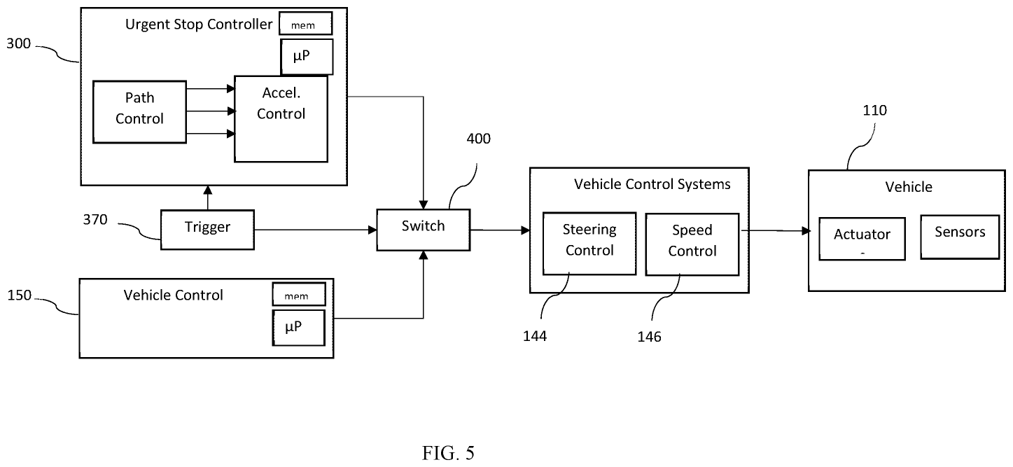

Referring now to FIG. 5 block diagram of an urgent stop controller 300 interacting with an autonomous vehicle 110. The autonomous vehicle 110 may comprise an intelligent urgent stop system, such as the IIUS system 300. The intelligent urgent stop system, for example, may be external or isolated from the autonomous vehicle 110, such as the IUS system 200.

The urgent stop controller 340 may continuously produce a safe-stop path and send the instruction to the switch 400. Concurrently, the vehicle control 150 may produce instruction and send the instruction to the switch 400. Under normal operating conditions, the switch defaults to pass the instruction from the vehicle control 140 to the steering control 144 and the speed control 146.

The IIUS system 300, for example, may comprise the emergency trigger 370. The emergency trigger 370 may send a signal to the urgent stop controller 340 upon the occurrence of an emergency trigger event, as discussed above. The emergency trigger 370 may also be communicatively coupled to the switch 400. Upon the occurrence of an emergency trigger event, the emergency trigger 370 may send a signal to the switch 400. The signal may indicate to the urgent stop controller to send the instruction to the vehicle. The signal may also indicate to the switch 400 to communicate the instruction from the urgent stop controller 340. The switch 400 may then at least temporarily stop sending information from the vehicle control 150 until a reset occurs.

Upon the occurrence of an emergency trigger event, the switch 400 may receive a signal from the emergency trigger, causing the instruction from the urgent stop controller 340 to be communicated to the steering control 144 and the speed control 146. The steering control 144 and the speed control 146 may then pass the urgent stop instruction to the actuators and sensors of autonomous vehicle 110.

Referring now to FIG. 6, FIG. 6 is a flowchart of an example process 500 for performing an intelligent urgent stop of an autonomous vehicle. The process 500 may include one or more additional blocks. The blocks shown in the process 500 may occur in any order and over any period of time. Any of the blocks shown in the process 500 may be removed, replaced, or may occur in any order.

Process 500 begins at block 505 where an autonomous vehicle proceeding along a path and is gathering vehicle information and environmental information. This can be shown, for example, in FIG. 4. The sensors, for example, may be part of a sensor array, such as senor array 179. The sensors, for example, may be separate from a sensor array integrated with the autonomous vehicle.

At block 510 the intelligent urgent stop system of the autonomous vehicle may identify obstacles in the path of the autonomous vehicle. The obstacle may be any obstacle, such as other vehicles, people, structures, or any object in the path of the vehicle.

The obstacles, for example, may be detected by sensors used in step 505 in gathering environmental data. These sensors may include but are not limited to RADAR and LiDAR systems associated with the vehicle.

At block 515 the intelligent urgent stop system may create an obstacle avoidance path and an acceleration/deceleration plan. The obstacle avoidance path and acceleration/deceleration plan may provide a set of instructions to safely bring the autonomous vehicle to a stop within a specified time-frame, which may be relative to the obstacle and potential paths. In addition, there may be several available obstacle avoidance paths and acceleration/deceleration plans available.

At block 520, the intelligent stop system may receive notification of an emergency trigger event. An emergency trigger event, for example, may include a notification of an obstacle in the path that must be avoided. An emergency trigger event, for example, may include a passenger in the autonomous vehicle proactively activating an urgent stop. The emergency trigger, for example, may be coupled to an indicator of a passenger of the autonomous vehicle. An interruption in such a biological indicator, for example, may act as an emergency trigger event.

Upon receiving notice of an emergency trigger event, the intelligent urgent stop system, may, at block 525, send the obstacle avoidance, acceleration instruction and/or deceleration instruction to the controller of the autonomous vehicle. The controller may then relay the instruction to the steering control system and the speed control system in order to bring the autonomous vehicle to safe stop.

The computational system 600, shown in FIG. 7 can be used to perform any of the examples described in this document. The computational system 600, for example, may be remotely located as a base station or located on an autonomous vehicle. For example, computational system 600 can be used to execute process 500. As another example, computational system 600 can be used perform any calculation, identification and/or determination described here. Computational system 600 includes hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard and/or the like; and one or more output devices 620, which can include without limitation a display device, a printer and/or the like.

The computational system 600 may further include (and/or be in communication with) one or more storage devices 625, which can include, without limitation, local and/or network accessible storage and/or can include, without limitation, a disk drive, a drive array, an optical storage device, a solid-state storage device, such as a random-access memory (“RAM”) and/or a read-only memory (“ROM”), which can be programmable, flash-updateable and/or the like. The computational system 600 might also include a communications subsystem 630, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 630 may permit data to be exchanged with a network (such as the network described below, to name one example), and/or any other devices described herein. The computational system 600, for example, will further include a working memory 635, which can include a RAM or ROM device, as described above.

The computational system 600 also can include software elements, shown as being currently located within the working memory 635, including an operating system 640 and/or other code, such as one or more application programs 645, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 625 described above.

In some cases, the storage medium might be incorporated within the computational system 600 or in communication with the computational system 600. The storage medium, for example, might be separate from a computational system 600 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 600 and/or might take the form of source and/or installable code, which, upon compilation and/or installation on the computational system 600 (e.g., using any of a variety of generally available compilers, installation programs, compression/decompression utilities, etc.) then takes the form of executable code.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more examples of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific examples thereof, it will be appreciated that those skilled in the art, upon attaining an understanding of the foregoing, may readily produce alterations to, variations of, and equivalents to such examples. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. An autonomous vehicle, comprising:
a speed control system;
a steering system;
an environmental sensor;
a geolocation sensor that produces geolocation data; and
an autonomous vehicle controller communicatively coupled with the speed control system, the steering system, the first environmental sensor, and the geolocation sensor, the autonomous vehicle controller directs the vehicle along a vehicle trajectory by sending signals to the speed control system and the steering control system;
an urgent stop environmental sensor;
an urgent stop controller coupled with the urgent stop environmental sensor, the urgent stop controller:
maps a safe-stop trajectory for the autonomous vehicle based on the vehicle trajectory data and environmental data received from the urgent stop environmental sensor, wherein the safe-stop trajectory ends in the autonomous vehicle being stopped; and
in response to an emergency trigger event, directs the autonomous vehicle to follow the safe-stop trajectory by sending signals to the speed control system and the steering system.

2. The autonomous vehicle according to claim 1, wherein the urgent stop environmental sensor sensors one or more obstacles, and wherein the safe-stop trajectory avoids the one or more obstacles.

3. The autonomous vehicle according to claim 1, wherein the vehicle trajectory data includes one or more of the following: velocity, geolocation, poise, heading, and position.

4. The autonomous vehicle according to claim 1, wherein the urgent stop environmental sensor includes one or more of the following: radar, lidar, visual sensor, and sonar.

5. The autonomous vehicle according to claim 1, wherein the emergency trigger event a trigger from the following: human input, a biological indicator, detection of unsafe conditions, and an emergency event.

6. The autonomous vehicle according to claim 1, wherein if the urgent stop environmental sensor does not sense an environmental obstacle, the safe-stop trajectory follows the vehicle trajectory.

7. The autonomous vehicle according to claim 1, wherein if urgent stop environmental sensor sense an environmental obstacle along the vehicle trajectory, the safe-stop trajectory does not follow the vehicle trajectory.

8. The autonomous vehicle according to claim 1, wherein the vehicle trajectory data comprises vehicle speed, and wherein the safe-stop trajectory comprises a deceleration from the vehicle speed to a stop.

9. The autonomous vehicle according to claim 1, wherein directing the autonomous vehicle to follow the safe-stop trajectory comprises sending an instruction to the autonomous vehicle controller.

10. A method comprising:
receiving vehicle trajectory data from a vehicle sensor on an autonomous vehicle;
receiving environmental data from an environmental sensor on the autonomous vehicle;
mapping a safe-stop trajectory for the autonomous vehicle based on the vehicle trajectory data and the environmental data, wherein the safe-stop trajectory ends in the autonomous vehicle being stopped;
directing the autonomous vehicle along a path;
receiving notification of an emergency trigger event; and
in response to receiving the emergency trigger event, directing the autonomous vehicle to follow the safe-stop trajectory.

11. The method according to claim 10, wherein the environmental data includes one or more obstacles, and wherein the safe-stop trajectory avoids the one or more obstacles.

12. The method according to claim 10, wherein vehicle trajectory data includes one or more of the following: velocity, geolocation, poise, heading, and position.

13. The method according to claim 10, wherein the environmental data includes one or more of the following: radar data, lidar data, visual data, and sonar data.

14. The method according to claim 10, wherein the emergency trigger event includes a trigger from the following: humanly input, a biological indicator, detection of unsafe conditions, and an emergency event.

15. The method according to claim 10, wherein if the environmental sensors does not sense an environmental obstacle, the safe-stop trajectory follows the path.

16. The method according to claim 10, wherein if the environmental sensors sense an environmental obstacle along the path, the safe-stop trajectory does not follow the path.

17. The method according to claim 10, wherein the vehicle trajectory data comprises vehicle speed, and wherein the safe-stop trajectory comprises a deceleration from the vehicle speed to a stop.

18. The method according to claim 10, wherein the directing the autonomous vehicle along a path includes receiving environmental data from a second environmental sensor on the autonomous vehicle.

19. The method according to claim 10, wherein directing the autonomous vehicle to follow the safe-stop trajectory comprises sending an instruction to an autonomous vehicle controller.

20. The method according to claim 10, wherein directing the autonomous vehicle to follow the safe-stop trajectory comprises sending an instruction to the autonomous vehicle's speed control system and/or the autonomous vehicle's steering control system.

21.-64. (canceled)
